(19) United States
(12) Patent Application Publication
(10) Pub. No.: US 2008/0087854 A1
(43) Pub. Date: Apr. 17, 2008

(54) Pressure Valve Control

(75) Inventor: Christoph Voss, Frankfurt am Main (DE)

Correspondence Address: CONTINENTAL TEVES, INC., ONE CONTINENTAL DRIVE, AUBURN HILLLS, MI, 48326-1581, US

(73) Assignee: Continental Teves AG & Co., oHG

(21) Appl. No.: 10/580,291

(22) PCT Filed: Nov. 5, 2004
(86) PCT No.: PCT/EP04/52824

§ 371 Date: May 24, 2006

(30) Foreign Application Priority Data
Nov. 29, 2003 (DE) 10355911.6
May 15, 2004 (DE) 102004024301.8

(51) Int. Cl. F16K 31/06

(52) U.S. Cl. 251/129.01

(57) ABSTRACT

The invention relates to a pressure control valve whose valve seat member (5) is fastened inside the valve housing (8) by means of a centering element (7) which guides the valve tappet (6).

The invention relates to a pressure control valve, particularly for controlling the hydraulic pressure in a motor vehicle transmission, according to the preamble of Claim 1.

DE 197 44 696 A1 already disclosed such a pressure control valve for regulating the hydraulic pressure in a motor vehicle transmission, where the valve tappet is guided at a distance from the valve closing element in sections in the valve housing. The pressure control valve is designed as a 3/2-way valve, so that, in addition to the valve closing element arranged in the flow path between the inlet and outlet ducts, via an additional valve closing element which acts as a throttling step at the valve tappet, an additional adjustable flow path to a leakage duct is formed, which leakage duct is closed by the throttling step, as soon as the ball-shaped valve closing element is lifted by the valve tappet from the valve seat.

The problem of the invention is to modify a pressure control valve of the indicated type in such a manner that, while simultaneously improving the functioning, an appropriate reduction of the manufacturing expenditure is reached using as simple as possible building means,

According to the invention, the posed problem is solved for a pressure control valve of the type mentioned in the introduction by the characterizing portions of Claim 1.

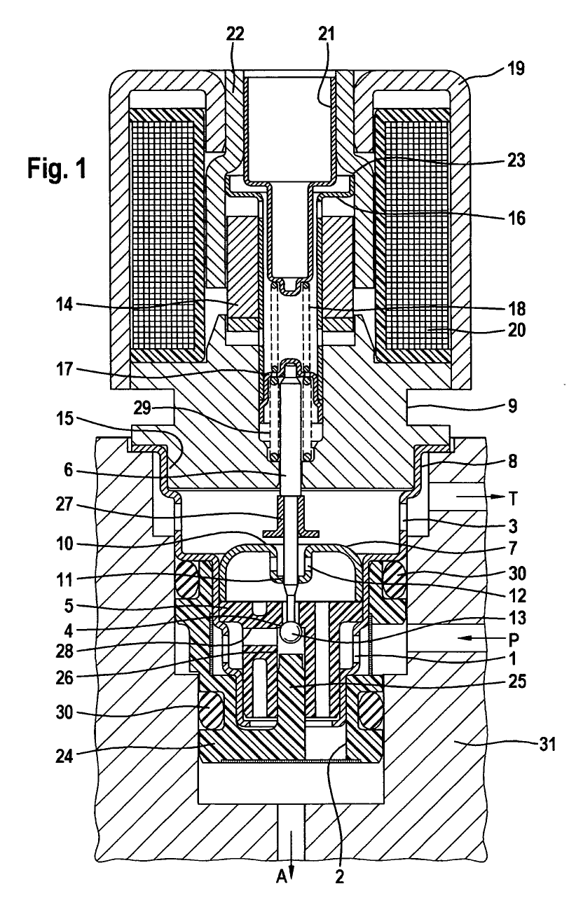

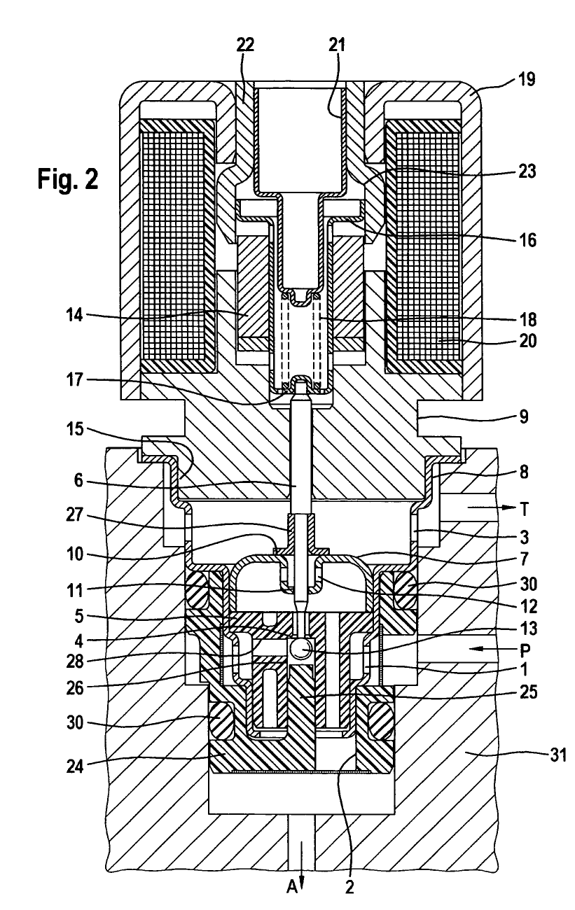

The measures indicated in the secondary claims provide advantageous embodiments of the invention, which are presented and explained in greater detail below in connection with the additional characteristics of advantages of the invention with reference to several drawings according to FIGS. 1 and 2.

In the drawing:

FIG. 1 shows a first advantageous embodiment of the invention represented on a pressure control valve, whose inlet duct, in the ground position of the ball-shaped valve closing element, is separated from the outlet and leakage duct,

FIG. 2 shows a second advantageous embodiment of the invention represented on a pressure control valve, whose inlet duct, in the ground position of the ball-shaped valve closing element, is connected, on the one hand, to the outlet duct, and, on the other hand, it is separated from the leakage duct,

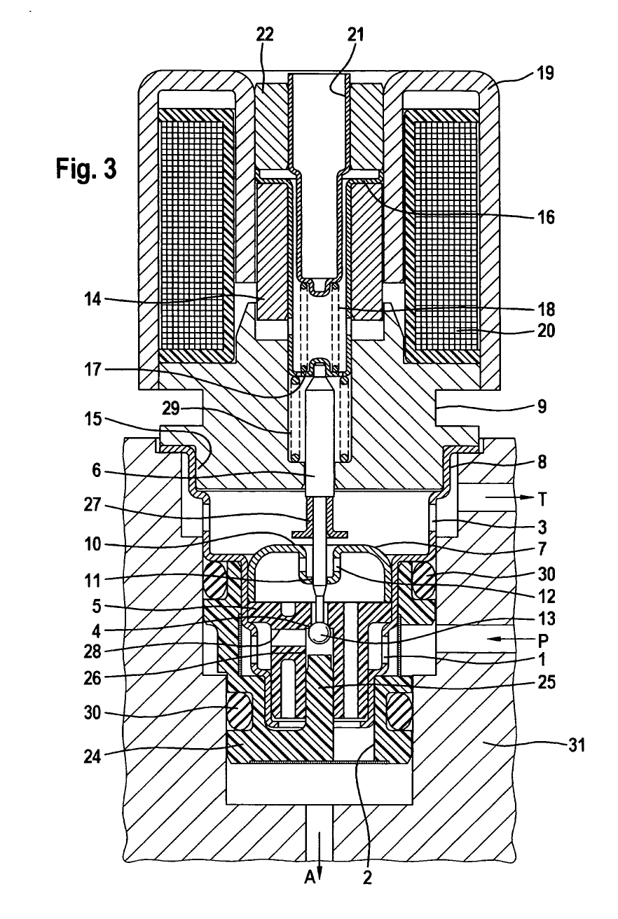

FIG. 3 shows a variant of individual characteristics of the pressure control valve according to FIG. 1, and

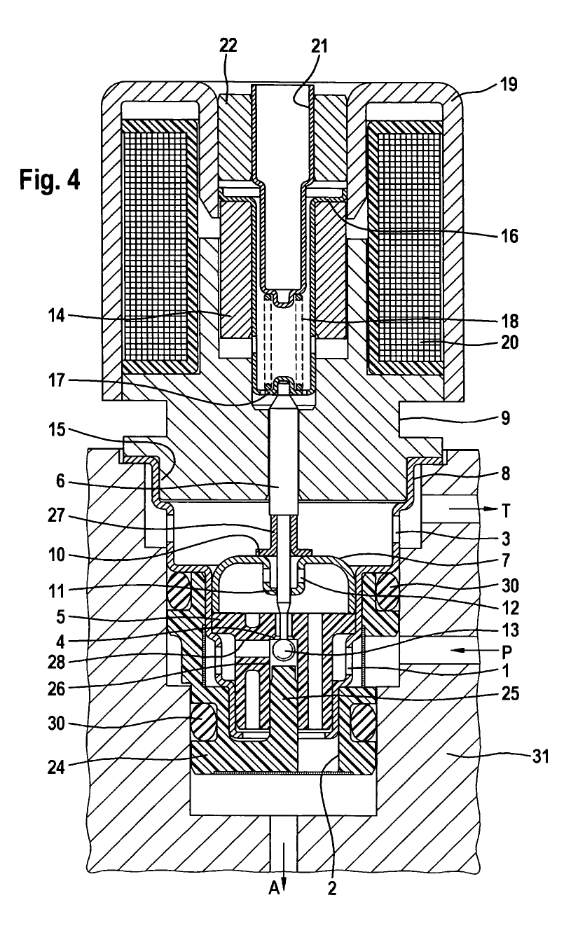

FIG. 4 shows a variant of individual characteristics of the pressure control valve according to FIG. 2.

In the following description, the common characteristics are first identified, which are used for both pressure control valves represented in FIGS. 1 and 2.

The pressure regulation valves, according to FIGS. 1, 2, are each shown in a longitudinal cross section and they are suitable, based on their design as 3/2-way seat valves, as preliminary control valves for regulating the hydraulic pressure in an automatic transmission of a motor vehicle. Each one of the two pressure control valves has a valve housing 8, 9, constructed in the cartridge design, in which a valve tappet 6 is guided, which works in cooperation with the first ball-shaped valve closing element 13, to disconnect or to connect the flow path between a first pressure medium connection 1 (inlet duct), which opens radially into the valve housing 8, 9, and a second pressure medium connection 2 (outlet duct), which opens axially from below into the valve housing. Furthermore, the valve housing 8, 9 receives a valve seat 4 which is turned toward the first valve closing element 13 as well as a magnetic armature 14, which actuates the valve tappet 6, and which is arranged inside a valve coil 20, which is arranged movably on the valve housing 8, 9.

For a reliable fixation of the valve seat member 5 presenting the valve seat 4 and also for the precise guidance of the valve tappet 6 in the direction to the valve seat 4, each one of the two pressure control valves is constructed in such a manner according to the invention that the valve seat member 5 is fixed by means of a centering element 7 guiding the valve tappet 6, in the valve housing 8, 9. The centering element for this purpose is preferably held by means of a particularly easily used press connection in the valve housing 8, 9.

Naturally connection measures with metallic continuity, frictional lock and/or another positive lock are also conceivable, and they can be used as desired or needed after evaluating the advantages and disadvantages.

For the pressure medium regulation in the direction of a so-called third pressure medium connection 3 (liquid leakage connection), a centering opening 11 arranged in the middle of the centering element 7, through which opening the valve tappet 6 extends, is provided, and, in addition, a passage 12 is arranged, for which purpose the pocket-shaped recess of the centering element 7 presents two punched out holes, which can be closed by a second valve closing element 27 attached to the valve tappet 6. The surface of the cap-shaped centering element 7, which surface is turned toward the additional valve closing element 27, therefore presents, to receive the additional valve closing element 27, a valve seat surface 10, which is adapted to the contour of the additional valve closing element 27, to be able, at any time, to disconnect the pressure medium connection between the two pressure medium ducts 1, 2 and the third pressure medium connection 3, as a function of the position of the valve tappet 6. In a particularly simple embodiment, the second valve closing element 13 is designed as a plate-shaped seat valve which is preferably actuated by punching, molding or deep drawing from a thin sheet metal to an annular disk, which is attached by means of a press fit to the valve tappet 6.

To be able to manufacture the valve housing also using small construction means and at as low cost as possible, said housing consists of a first and a second housing part 8, 9, where the first housing part is designed as a housing pot which can be manufactured by the deep drawing method, and into which the valve seat member 5 with the centering element 7 is pressed. The first housing part 8 is attached in a pressure medium-proof manner by means of a press connection to the collar 15 of the second housing part 9 in a particularly simple manner, where the second housing part 9 is designed to receive the parts of relevance for the magnetic circuit (magnetic armature 14, valve coil 20) as a tubular, cold flow molded part or turned part.

For a cost advantageous manufacture, the magnetic armature 14 is designed as a hollow cylinder, into which a magnetic armature sleeve 16 manufactured by the deep drawing method is pressed, which sleeve protrudes with its ends on both sides of the front surfaces of the magnetic armature 14. The bottom sleeve end presents an abutment 17 for the valve tappet 6, while on the side of the abutment 17, which side is turned away from the valve tappet 6, a compression spring 18 is accommodated in a space saving manner inside the magnetic armature sleeve 16, and an adjustment sleeve 21, which is adjusted in the yoke ring 19, acts upon said compression spring.

The yoke ring 19 consists of a sheet metal part which has been manufactured by the deep drawing method, and which is put over the external circumference of the valve coil 20. The yoke ring 19 is crimped inward with its end which is turned away from the valve housing 9 over the upper edge of the valve coil 20 and fastened by means of a press connection to a pipe 22, whose end extends at a distance from the crimpled area between the valve coil 20 and the magnetic armature 14 in the direction toward the front surface of the second housing part 9. For reaching the ground position of the magnetic armature 14, the pipe following its press fitting area in the yoke ring 19, presents a stepped section (23) with enlarged diameter, against which the magnetic armature sleeve (16) is braced.

A filter pot 24 provided with a ring filter fabric is pressed on the first housing part 8, where, on the floor of the filter pot 24, a pin 25 is arranged, which closes a stepped bore 26 arranged in the middle of the valve seat member 5, in which stepped bore the first valve closing element 13 is inserted. Above the pin 25, a transverse duct 28 opens into the stepped bore 26, which transverse duct is permanently fastened to the first pressure medium connection 1, which opens radially into the wall of the first housing part 8. The second pressure medium connection 2 extends as a longitudinal duct eccentrically through the floor of the filter pot 24 as well as through the bottom of the valve seat member 5 into the cavity of the first housing part 8, in which the centering element 7 is located and from there it is connected (as a function of the position of the two valve closing elements 13, 27) to the first and/or to the third pressure medium connection 1, 3.

The filter pot 24 is made of plastic, which presents at both ends circumferential grooves, into which the sealing rings 30 are inserted, which are applied with seal along the bore wall of a valve carrier 31 receiving the pressure control valve. On the upper edge of the valve carrier 31, the pot-shaped housing part 8 rests with its radially outwardly crimped margin, where on a projection of the second housing part 9, due to the action of an axial assembly force, the pressure control valve is held in the valve carrier 31.

Disregarding the common features of the two pressure control valves, which have been presented until now, the differences between the valves will now be described.

In the embodiment according to FIG. 1, the ball-shaped first valve closing element 13 is in the electromagnetically unexcited ground position of the magnetic armature 14 in its depicted closed position on the valve seat 4, because, between the pot-shaped abutment 17 and the second housing part 9, a return spring 29 is arranged, whose force is greater than that of the opposing force of the compression spring 18. At the same time, the additional plate-shaped valve closing element 27 is lifted from the valve seat surface 10, so that through the longitudinal duct of the valve seat member 5 the second pressure medium connection 2 is fastened exclusively to the third pressure medium connection 3.

As soon as, due to the electromagnetic excitation of the magnetic armature 14, the ball-shaped valve closing element 13 is lifted by the valve tappet 6 from the valve seat 4, the size of the passage in the valve seat member 5 increases inversely proportionally to the passage in the centering element 7, so that the passage in the direction toward the third pressure medium connection 3 is gradually down regulated, when the valve seat 4 between the first and second pressure medium connection 1, 2 is increasingly cleared.

On the other hand, the functioning of the pressure control valve according to FIG. 2 is exactly the reverse, because the ball-shaped valve closing element 13 in the electromagnetically unexcited ground position of the magnetic armature 14 is lifted from its valve seat 4, and the plate-shaped valve closing element 27 is necessarily closed. Accordingly, in this valve ground position, there exists only a pressure medium connection between the first and second pressure medium connection 1, 2, while the third pressure medium connection 3 is disconnected from this. It is only when the magnetic armature 14 is magnetically excited that the functional processes are again reversed, by releasing the ball-shaped valve closing element 13 from the valve tappet 6, as a result of which, to disconnect the connection of the first to the second pressure medium 1, 2, the ball can be applied against the valve seat 4, while the-plate-shaped valve closing element 27 in the continuous synchronous movement moves away from its valve seat surface 10, to connect the second pressure medium connection 2 exclusively to the third pressure medium connection 3.

In a deviation from the embodiment example according to FIG. 1, the pipe 22 in the valve construction according to FIG. 2, additionally assumes the function of a magnetic core, resulting in a surprisingly simple construction of the magnetic core.

The pressure control valve according to FIG. 3 differs from the pressure control valve according to FIG. 1 in that it has a yoke ring 19 which, in the inner area of the valve coil 20, is pulled down particularly deeply in the direction of the valve housing 9, in which the magnetic armature 14 is guided. As a result, the pipe 22 with constant diameter can be designed particularly simply as a part produced by cold heading or deep drawing. Moreover, the pressure control valve according to FIG. 3 differs from the pressure control valve according to FIG. 1 in that the magnetic armature sleeve 16 is designed as a single part, with abutment. The other depicted characteristics of the pressure control valve according to FIG. 3 can be obtained from the description part for FIG. 1.

The pressure control valve according to FIG. 4 differs from the pressure control valve according to FIG. 2 by a yoke ring 19 which is pulled down deeper, in the interior of the valve coil 20, in the direction of the valve housing 9, in which yoke ring the magnetic armature 14 is guided in the upper terminal area. As a result, the pipe 22 can be designed with constant diameter in a particularly simple manner as a part produced by cold heading or deep drawing. The additionally shown characteristics of the pressure control valve according to FIG. 4 can be obtained from the description part for FIG. 2.

As a result of the described changes in the details of the pressure control valves according to FIGS. 1, 2, which are reflected in FIGS. 3, 4, identical components, with the exception of the yoke ring 19 and the valve housing 9, can be used both for the embodiment of the pressure control valve as a closed seat valve in the ground position (FIGS. 1, 3) and in the embodiment of the pressure control valve as an open seat valve in the ground position (FIGS. 2, 4).

### Parts List

1 Pressure medium connection
2 Pressure medium connection
3 Pressure medium connection
4 Valve seat
5 Valve seat member
6 Valve tappet
7 Centering element
8 Valve housing
9 Valve housing
10 Valve seat surface
11 Centering opening
12 Passage
13 Valve closing element
14 Magnetic armature
15 Collar
16 Magnetic armature sleeve
17 Abutment
18 Compression spring
19 Yoke ring
20 Valve coil
21 Adjusting sleeve
22 Pipe
23 Stepped section
24 Filter pot
25 Pin
26 stepped bore
27 Valve closing element
28 Transverse duct
29 Return spring
30 Sealing ring
31 Valve carrier

1.-13. (canceled)

14. A pressure control valve with a valve tappet guided in a valve housing, which tappet presents at least a first valve closing element for disconnecting or connecting a first pressure medium connection from or to a second pressure medium connection, with a valve seat turned toward the first valve closing element, as well as with a magnet armature actuating the valve tappet and with a valve coil arranged on the valve housing, wherein the armature is arranged movably inside the valve coil, and with an independently operable valve seat member (5), which is fixed in the valve housing by means of a centering element (7) which guides the valve tappet (6), wherein the valve seat (4) is arranged inside the valve seat member (5).

15. The electromagnetic valve according to claim 14, wherein the centering element (7) is held in the valve housing.

16. The electromagnetic valve according to claim 14, wherein the centering element (7) presents a valve seat surface (10) and, to guide the valve tappet (6), a centering opening (11), and wherein, beside being provided with the centering opening (11), the centering element (7) is perforated by at least one passage (12), which can be closed by means of a second valve closing element (13), which is applied on the valve tappet (6) and can be applied on the valve seat surface (10) of the centering element (7), in the direction of a third pressure medium connection (3)

17. The electromagnetic valve, according to claim 16, wherein the second valve closing element (13) is designed as a plate-shaped seat valve.

18. The electromagnetic valve according to claim 17, wherein the second valve closing element is manufactured from a thin sheet metal which is pressed on the valve tappet (6).

19. The electromagnetic valve according to claim 14, wherein the valve housing consists of a first and a second housing part (8, 9), where the first housing part (8) is designed as a housing pot which can be manufactured by the deep drawing method, into which pot the valve seat member (5) and the centering element (7) are pressed.

20. The electromagnetic valve according to claim 19, wherein the first housing part (8) is attached by means of a press connection to the second housing part (9), which is designed to receive a magnetic armature (14) as a tubular part, which presents a collar (15), against which the first housing part (8) is applied.

21. The electromagnetic valve according to claim 19, wherein a filter pot (24), which is provided with a ring filter fabric, is pressed onto the first housing part (8) where, on the floor of the filter pot (24), a pin (25) is arranged, which closes a stepped bore (26), arranged in the middle of the valve seat member (5), into which stepped bore the first valve closing element (27) is inserted.

22. The electromagnetic valve according to claim 21, wherein above the pin (25) a transverse duct (28) opens into the stepped bore (26), which transverse duct is connected with the first pressure medium connection (1), which opens radially into the wall of the first housing part (8).

23. The electromagnetic valve according to claim 21, wherein the second pressure medium connection (2) extends, as a longitudinal duct eccentrically through the floor of the filter pot (24) as well as through the floor of the valve seat member (5) into the cavity of the centering element (7) and from there it is connected, as a function of the position of the two valve closed elements (13, 27) to the first and/or to the third pressure medium connection (1, 3).

24. The electromagnetic valve according to claim 14, wherein the magnetic armature (14) is designed as a hollow cylinder, into which a magnetic armature sleeve (16) is pressed, which sleeve protrudes with its ends on both sides of the front surfaces of the magnetic armature (14).

25. The electromagnetic valve according to claim 24, wherein one sleeve end presents an abutment (17) for receiving the valve tappet (6), and wherein, on the side of the abutment (17), which side is turned away from the valve tappet (6), a compression spring (18) rests, which is arranged inside the magnetic anchor sleeve (16) and which is acted upon by an adjusting sleeve (21), which is adjusted in the yoke ring (19) of the valve coil (20).

26. The electromagnetic valve according to claim 25, wherein the yoke ring (19) consists of a sheet metal part which has been manufactured by the deep drawing method, which is put over the external circumference of the valve coil (20), and which is fastened in the inwardly crimped area to a pipe (22), which extends between the valve coil (20) and the magnetic armature (14).

27. The electromagnetic valve according to claim 26, wherein for reaching a ground position of the magnetic armature (14), the pipe (22) comprises a stepped section (23) with expanded diameter on which the magnetic armature sleeve (16) rests.
